(19) United States
(12) Patent Application Publication
(10) Pub. No.: US 2014/0069896 A1
(43) Pub. Date: Mar. 13, 2014

(54) LIGHT WEIGHT HIGH POWER LASER PRESURE CONTROL SYSTEMS AND METHODS OF USE

(71) Applicants: Paul D. Deutch, Houston, TX (US); Ronald A. De Witt, Katy, TX (US); Mark S. Zediker, Castle Rock, CO (US); Brian O. Faircloth, Evergreen, CO (US); Daniel L. Wolfe, Houston, TX (US)

(72) Inventors: Paul D. Deutch, Houston, TX (US); Ronald A. De Witt, Katy, TX (US); Mark S. Zediker, Castle Rock, CO (US); Brian O. Faircloth, Evergreen, CO (US); Daniel L. Wolfe, Houston, TX (US)

(73) Assignee: FORO ENERGY, INC., Denver, CO (US)

(21) Appl. No.: 14/021,724

(22) Filed: Sep. 9, 2013

Related U.S. Application Data
(60) Provisional application No. 61/698,703, filed on Sep. 9, 2012.
(60) Provisional application No. 61/698,975, filed on Sep. 10, 2012.

(51) Int. Cl. B23K 26/38

(52) U.S. Cl. CPC B23K 26/38
USPC 219/121.67

(57) ABSTRACT

There is provided pressure control systems, methods and apparatus for the use of high power laser energy to server structures, such as rods, tubes, wireline, slickline and braided line in well and pipeline pressure control situations.

This application: (i) claims, under 35 U.S.C. §119(e)(1), the benefit of the filing date of Sep. 9, 2012, of provisional application Ser. No. 61/698,703; and (ii) claims, under 35 U.S.C. §119(e)(1), the benefit of the filing date of Sep. 10, 2012, of provisional application Ser. No. 61/698,975, the entire disclosures of each of which are incorporated herein by reference,

### BACKGROUND OF THE INVENTION

1. Field of the Invention

The present inventions relate to the delivery of high power laser energy for use in, and with, well and pipeline access control devices, modules, and systems.

As used herein, unless specified otherwise, “high power laser energy” means a laser beam having at least about 1 kW (kilowatt) of power. As used herein, unless specified otherwise “great distances” means at least about 500 m (meter). As used herein, unless specified otherwise, the term “substantial loss of power,” “substantial power loss” and similar such phrases, mean a loss of power of more than about 3.0 dB/km (decibel/kilometer) for a selected wavelength. As used herein the term “substantial power transmission” means at least about 50% transmittance.

As used herein, unless specified otherwise, the term “earth” should be given its broadest possible meaning, and includes, the ground, all natural materials, such as rocks, and artificial materials, such as concrete, that are or may be found in the ground, including without limitation rock layer formations, such as, granite, basalt, sandstone, dolomite, sand, salt, limestone, rhyolite, quartzite and shale rock.

As used herein, unless specified otherwise, the term “borehole” should be given it broadest possible meaning and includes any opening that is created in a material, a work piece, a surface, the earth, a structure (e.g., building, protected military installation, nuclear plant, offshore platform, or ship), or in a structure in the ground, (e.g., foundation, roadway, airstrip, cave or subterranean structure) that is substantially longer than it is wide, such as a well, a well bore, a well hole, a micro hole, slimhole and other terms commonly used or known in the arts to define these types of narrow long passages. Wells would further include exploratory, production, abandoned, reentered, reworked, and injection wells.

As used herein, unless specified otherwise, the term “tubular” is to be given its broadest possible meaning and includes drill pipe, casing, riser, coiled tube, composite tube, vacuum insulated tubing (“VIT), production tubing and any similar structures having at least one channel therein that are, or could be used, in the drilling industry. As used herein the term “joint” is to be given its broadest possible meaning and includes all types of devices, systems, methods, structures and components used to connect tubulars together, such as, threaded pipe joints and bolted flanges. For drill pipe joints, the joint section typically has a thicker wall than the rest of the drill pipe. As used herein the thickness of the wall of tubular is the thickness of the material between the internal diameter of the tubular and the external diameter of the tubular.

As used herein, unless specified otherwise, the terms “drilling blowout preventer,” “drilling BOP,” and “drilling BOP stack” mean, and include devices positioned at or near the borehole surface, e.g., the surface of the earth including dry land or the seafloor, which are used to contain or manage pressures or flows associated with a borehole during drilling activities and have the capability to seal against and shear off jointed drill pipe and jointed casing strings that are being advanced through the drilling BOP during drilling operations . . . .

As used herein, unless specified otherwise, “offshore” and “offshore activities” and similar such terms are used in their broadest sense and would include activities on, or in, any body of water, whether fresh or salt water, whether manmade or naturally occurring, such as, rivers, lakes, canals, inland seas, oceans, seas, bays and gulfs, such as the Gulf of Mexico. As used herein, unless specified otherwise the term “offshore rig” is to be given its broadest possible meaning and would include fixed towers, tenders, platforms, barges, jack-ups, floating platforms, drill ships, dynamically positioned drill ships, semi-submersibles and dynamically positioned semi-submersibles. As used herein, unless specified otherwise the term “seafloor” is to be given its broadest possible meaning and would include any surface of the earth that lies under, or is at the bottom of, any body of water, whether fresh or salt water, whether manmade or naturally occurring.

As used herein, unless specified otherwise, the term “fixed platform,” would include any structure that has at least a portion of its weight supported by the seafloor. Fixed platforms would include structures such as: free-standing caissons, well-protector jackets, pylons, braced caissons, piled-jackets, skirted piled-jackets, compliant towers, gravity structures, gravity based structures, skirted gravity structures, concrete gravity structures, concrete deep water structures and other combinations and variations of these. Fixed platforms extend from at or below the seafloor to and above the surface of the body of water, e.g., sea level. Deck structures are positioned above the surface of the body of water a top of vertical support members that extend down in to the water to the seafloor.

As used herein, unless specified otherwise, the terms “seafloor,” “seabed” and similar terms are to be given their broadest possible meaning and would include any surface of the earth, including for example the mud line, that lies under, or is at the bottom of, any body of water, whether fresh or salt water, whether manmade or naturally occurring.

As used herein, unless specified otherwise the terms “well” and “borehole” are to be given their broadest possible meaning and include any hole that is bored or otherwise made into the earth's surface, e.g., the seafloor or seabed, and would further include exploratory, production, abandoned, reentered, reworked, and injection wells.

As used herein, unless specified otherwise, the term “drill pipe” means and includes all forms of pipe used for drilling activities; and refers to a single section or piece of pipe. As used herein, unless specified otherwise, the terms “stand of drill pipe,” “drill pipe stand,” “stand of pipe,” “stand” and similar type terms are to be given their broadest possible meaning and include two, three or four sections of drill pipe that have been connected, e.g., joined together, typically by joints having threaded connections. As used herein, unless specified otherwise, the terms “drill string,” “string,” “string of drill pipe,” string of pipe” and similar type terms are to be given their broadest definition and would include a stand or stands joined together for the purpose of being employed in a borehole. Thus, a drill string could include many stands and many hundreds of sections of drill pipe. These terms would not include continuous, e.g., non-jointed, conveyance structures such as line structures and coiled tubing.

As used herein, unless specified otherwise, the term “pipeline” should be given its broadest possible meaning, and includes any structure that contains a channel having a length that is many orders of magnitude greater than its cross-sectional area and which is for, or capable of, transporting a material along at least a portion of the length of the channel. Pipelines may be many miles long and may be many hundreds of miles long. Pipelines may be located below the earth, above the earth, under water, within a structure, or combinations of these and other locations. Pipelines may be made from metal, steel, plastics, ceramics, composite materials, or other materials and compositions know to the pipeline arts and may have external and internal coatings, known to the pipeline arts. In general, pipelines may have internal diameters that range from about 2 to about 60 inches although larger and smaller diameters may be utilized. In general natural gas pipelines may have internal diameters ranging from about 2 to 60 inches and oil pipelines have internal diameters ranging from about 4 to 48 inches. Pipelines may be used to transmit numerous types of materials, in the form of a liquid, gas, fluidized solid, slurry or combinations thereof. Thus, for example pipelines may carry hydrocarbons; chemicals; oil; petroleum products; gasoline; ethanol; biofuels; water; drinking water; irrigation water; cooling water; water for hydroelectric power generation; water; or other fluids for geothermal power generation; natural gas; paints; slurries, such as mineral slurries, coal slurries, pulp slurries; and ore slurries; gases, such as nitrogen and hydrogen; cosmetics; pharmaceuticals; and food products, such as beer.

As used herein, unless specified otherwise, the terms “well services,” “intervening,” “intervention,” “workover,” “completion” and “workover and completion,” and similar such terms should be given their broadest possible meanings and would include activities that place at or near the completion of a well, activities that take place at or the near the commencement of production from the well, activities that take place on the well when the well is a producing or operating well, activities that take place to reopen or reenter an abandoned or plugged well or branch of a well, and would also include for example, perforating, logging, measuring, cementing, acidizing, fracturing, pressure testing, the removal of well debris, removal of plugs, insertion or replacement of production tubing, repairing conductors, removal of down hole equipment, placement of down hole equipment, forming windows in casing to drill or complete lateral or branch wellbores, cutting and milling operations in general, insertion of screens, stimulating, cleaning, testing, analyzing and other such activities. These terms would further include applying heat, directed energy, preferably in the form of a high power laser beam to heat, melt, soften, activate, vaporize, disengage, desiccate, remove, assist in their removal, cleanout, condition, materials and structures in a well, and combinations and variation of these.

As used herein, unless specified otherwise, the terms “pipe line services” and “pipe line intervention,” and similar such terms should be given their broadest possible meanings and would include activities that take place at or near the completion of a pipe line, activities that take place at or the near the commencement of flow in a pipe line, activities that take place on the pipe line when material is flowing in the pipe line, activities that take place when flow has been suspended in the pipeline, activities that take place when the pipe line is under a pressure that is different from atmosphere or the ambient environment, and would including activities such as, cleaning, measuring, repairing, analyzing, removing, and combinations and variations of these.

As used herein, unless specified otherwise, the terms “line structure,” “line” and similar such terms, should be given its broadest possible meanings, and would include without limitation: wireline; coiled tubing; a tube in a tube, double walled coiled tubing; slickline; braided line; wireline; umbilicals, cables supporting or associated with a PIG; laser cables for a laser-PIG; heavy duty die-formed fishing line; logging cable; electric line; mono-conductor wireline; coaxial mono-conductor line for perforation and production; cable structures used for completion, workover, drilling, seismic, sensing, logging, scale removal, wax removal, pipe cleaning, casing cleaning, cleaning of other tubulars; cable structures used for subsea completion and other subsea activities; umbilicals; cable structures used for ROV control power and data transmission; lines structures made from metal, steel, wire and composite materials such as carbon fiber, wire and mesh: line structures used for monitoring and evaluating pipeline and boreholes; and structures such as Power & Data Composite Coiled Tubing (PDT-COIL) Smart Pipe® and FLATpak®.

2. Discussion of Related Art

Well Services, Intervention, Workover, Completion, and Pipeline

In addition to drilling a well, there are many other activities that may take place during drilling, after drilling is complete, while the well is producing hydrocarbons, a source of geothermal energy, water, or some other material from the earth, and during the sensation of production, after production has stopped, and before and during the recommencement of production. Such well services, intervention, workover and completion activities may be performed using various types of line structures and devices for entering into the well. The toughness, e.g., strength, durability, shear strength, tensile strength, ductility, and combinations and variations of such properties, of these structures and devices, such as tube, rod and line structures, have been steadily increasing, and it is believed will continue to increase. With increasing toughness, these devices and structures have found more and more uses and applications.

Pipeline services may, and do, involve some similar services to well services, such as cleaning, scraping, repairing, measuring, and observing. Pipeline services may also be, and in many situations are, performed on a pipeline that is under pressure, contains a fluid, is flowing, and combinations and variations of these. In the use of PIGs to perform such services, and in particular laser-PIGs (see U.S. patent application Ser. No. 13/366,882, the entire disclosure of which is incorporated herein by reference), line structures, such as umbilicals, may be used with the PIG and extend from the inside (pressure, flowing side) of the pipeline to the outside ambient environment (e.g., above ground, below ground, under a body of water, under the sea floor, etc). In these pipe line applications, pressure control systems, devices and methods will need to be employed, which should properly operate, if an issue or need arises where the point of entry into or exit from the pipeline for the line structure needs to be quickly sealed off.

The use of tube, rod and line structures and other intervention devices and structures can present a significant cost savings because of their smaller diameter, lighter weight and easy of deployment and retrieval. Such cost savings, and other advantages, may be realized in well, chemical plant, nuclear facilities and pipeline services. For example, in workover activities use of a line structure has several advantages, when compared to jointed drilling pipe. Because of their relatively small size, line structures can be deployed with lighter, smaller and less expensive deployment units than drill pipe. Line structures can be utilized in ways that are quicker, cheaper, and less risky for the environment and personnel than drill pipe. The use of line structures for services and intervention activities can minimize, reduce, or eliminate lost production, among other benefits and advantages.

Many, most, and possibly the vast majority, of well services, intervention, workover, and completion activities take place in situations where well pressure, flow, and both, need to be managed, controlled, regulated or otherwise addressed. However, the increasing toughness, and smaller diameter, of line structures, as well as other devices and structures, has made it ever more difficult to cut these structures in a pressure management situation, emergency situation, or other situation where the well needs to be shut off, closed, or otherwise have the pressure, flow or both regulated, managed or contained. Thus, larger, heavier, and more power BOPs are needed to cut through these structures; even though such increased size is, in many situations, may not necessarily be needed to otherwise manage the pressures encountered during well service, intervention, workover and completion activities. This, need for, and use of, such larger BOPs adds increased cost, increased time, and may require additional lifting units, equipment, modifications to the well site to accommodate the BOP's size, and other factors that are contrary to, mitigate against, or reduce the benefits of using structures such as line structures.

Thus, there has long been a long standing need, which is increasing, for devices, apparatus, systems and methods, that can quickly and reliably cut line and other type structures, when such cutting is necessary, required or beneficial, during well service, intervention, workover and completion, pipe line, or other activities; and to do so in a smaller, lighter weight, and more easily useable system; and to do so in a manner that controls or manages pressure or flow and combinations and variation of these. This need has grown ever more important as the toughness of these structures, e.g., line structures, has increased.

### SUMMARY

There has been a long standing need for improved systems that can provide safe and effective control of well, pipeline, and other conditions, and in particular, to do so during the use of devices and structures for servicing, assembling, inspecting, maintaining, constructing, intervening, repairing, enhancing, recovering, or other activities. The present inventions, among other things, solve these and other needs by providing the articles of manufacture, devices and processes taught herein.

Thus, there is provided herein the systems, devices, apparatus and methods set forth in the claims, specification and drawings.

### BRIEF DESCRIPTION OF THE DRAWINGS

FIG. 1A is a perspective view of an embodiment of a laser pressure control device in accordance with the present invention.

FIG. 1B is a cross sectional view of the device of FIG. 1A.

FIG. 2 is a perspective view of an embodiment of a laser slickline stuffing box in accordance with the present invention.

In FIG. 3 is a perspective view of an embodiment of a laser stuffing box in accordance with the present invention.

FIG. 4 is a schematic of an embodiment of a laser line structure valve assembly in accordance with the present invention.

FIG. 5 is a perspective view of an embodiment of an intervention laser cutting device in accordance with the present invention.

FIG. 6A is an embodiment of a laser cutting head in accordance with the present invention.

FIG. 6B is an embodiment of a laser cutting head in accordance with the present invention.

FIG. 6C is an embodiment of a laser cutting head in accordance with the present invention.

FIG. 6D is an embodiment of a laser cutting head in accordance with the present invention.

FIG. 6E is an embodiment of a laser cutting head in accordance with the present invention.

FIG. 7 is a perspective view, and an enlarged sectional view, of an embodiment of a wireline/slickline laser intervention pressure control system in accordance with the present invention.

FIG. 7A is a perspective view of the embodiment of FIG. 7, in an embodiment of a wireline/slickline laser intervention pressure control system in accordance with the present invention.

FIGS. 8A, 8B, 8C and 8D are schematic snap shot views of an embodiment of a process in accordance with the present invention.

FIG. 9 is a schematic view of an embodiment of a wireline/CT laser cutting device in accordance with the present invention.

FIG. 10 is a prospective view of an embodiment of a laser line structure pressure management system in accordance with the present invention.

FIG. 11 is a schematic view of an embodiment of a laser line structure pressure management system in accordance with the present invention.

### DESCRIPTION OF THE PREFERRED EMBODIMENTS

The present inventions relate to the delivery and utilization of high power laser in pressure control systems, devices and applications; and in particular, to systems, methods and structures for utilizing high power laser energy in well service, intervention, workover and completion activities, in pipeline activities, in chemical plant activities, in refining activities, in nuclear plant activities, and in other locations or facilities where pressure control or management could be beneficial or needed.

Generally, pressure control systems and methods utilize various mechanical devices and techniques to control and manage pressure and flow conditions during activities, such as for in example in a well or pipeline during activities, such as, servicing, intervening, working over and completing activities. Such well and pipeline systems perform many and varied activities and have many and varied applications. For example, and generally, one such application is the mechanical shutting in, shutting off, or otherwise closing, or partially closing, of a well or pipeline to prevent, mitigate, or manage a leak, blowout, kick, or such type of uncontrolled, unanticipated, emergency, or in need of control, event.

Generally, in such situations where the well is being closed, the associated well control devices are intended to close the well quickly and under any, and all, conditions, e.g., for any and all types of line structure(s), or other structures, such as rods and tubing, that may be present, in use, and in an area where they may interfere with, or otherwise obstruct, the closing of the well, such as, by the closing of a valve, such as, a ball, flap, or gate valve or the closing of an intervention BOP.

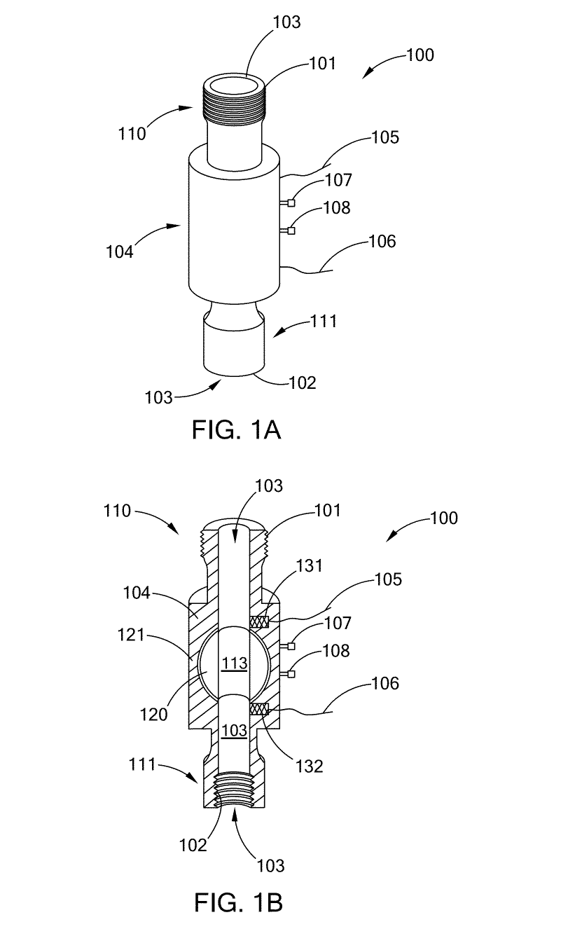

Turning to FIG. 1A there is shown a perspective view of an embodiment of a laser pressure control device that may be used as part of, or in conjunction with, for example, other wireline, slickline, or other line structure handling and deployment equipment and methods. The pressure control device 100 has a body 104 and extending from the body 104 is a first connection section 110 having external threads 101 and extending from the other side of the body 104 is a second connection section 111 having internal threads 102. There is a cavity 103 that opens from the first connection section 110. The cavity 103 extends from and through the first connection section 110; to and through the body 104; and from the body 104 to and through the second connection section 111; and opens from that section. Although threaded connections are shown, any other type of connection known to the art, or later developed, may be used, provided such connections meet pressure management, and any other operational requirements. A first high power laser cable 105 enters the body 104, and a second high power laser cable 106 enters the body 104. A single laser cable, three, four or more laser cables may be used; and one or more of the laser cables may enter the device through other sections or components of the device. When in use, or deployed, the high power laser cables are optically associated with a high power laser as a source for providing a high power laser beam. A fiber may be used in a cable or two, three, four or more fibers may be used in a cable. Activation stems 107, 108 provide for connection to control lines for controlling the valve 120 that is positioned with the body 104, sensor, data and monitoring lines may also enter and exit through these or other ports in the device 100.

Turning to FIG. 1B, there is shown a cross sectional view of the laser pressure control device 100 of FIG. 1A. There is a ball valve 120, shown in the open position, and thus the cavity 113 in the ball valve 120 is in line with, and does not block the cavity 103. The body 104 has a minimal wall thinness 121, which preferably is based upon the pressure requirements for a particular application, plus acceptable safety margins; but which more preferably does not have to be based upon the strength of the line structures to be used, or a force requirement to close the ball valve by cutting such line structures that may be interfering with the closure of the ball valve.

In addition to ball valves, other types of valves and closing assemblies may be used in conjunction with laser beam delivery devices, e.g., laser cutters, such as, gate valves, flap valves, intervention DOPs, workover BOPs, wireline BOPs, other types of closure assemblies that are used for example in the oil field, chemical plants, refineries, nuclear plants or with pipelines, and closure assemblies that may be later developed. Preferably, the body, housing or walls of such other valves and closing assemblies has a minimal wall thinness 121, which preferably is based upon the pressure requirements for a particular application, plus acceptable safety margins; but which more preferably does not have to be based upon the strength of the line structures to be used, or a force requirement to close the valve or other closures assembly by cutting such line structures that may be interfering with closure.

Turning back to the embodiment of FIGS. 1A and 1B, a first laser cutter 131 and a second laser cutter 132 that are located within the body 104. These laser cutters may be positioned at other locations within, on, or associated with the body 104, or within, on, or associated with the device 100. They may be in a separate, separable, fixed or integral ring, module or device that is positioned between the body 104 and the connection sections 110, 111. They may be in a connection section, e.g., 110. They may be a separate module, ring or device that attaches to a connection section. The lasers cutters, may scan the laser beam, rotate the laser beam around the cavity, provide a fan shaped laser beam, provide a laser beam having a predetermined shape (such a line, a rectangle, s square, a spot, an ellipse), provide a spoke like laser beam patter with a plurality of laser beams forming the spokes, have a laser beam(s) travel across the cavity, and other combinations and variations of these and other methods of laser beam delivery. They may provided for one, two, three, four or more laser beam delivery paths, and have laser beams travel, i.e., be propagated along, these paths. One, two, three or more laser cutters may be used in a laser pressure control device, with each providing one, two three, four or more laser beam paths, and laser beams along those paths.

In operation the laser beam(s) performs some, most, and preferably all of the cutting of any line structure that is present in the space, area, or location, e.g., cavity 103, ball valve cavity 113, where the closing member, e.g., ball valve 120, resides, passes through, or is otherwise present when activated to close or seal off a well. Thus, a laser pressure control device need only have sufficient strength to contain any pressure that the device may be exposed to (plus any additional safety margins). Preferably, it does not need extra strength to hold, or other wise handle, the forces needed to mechanical shear a line structure, because the laser beam(s) are performing this activity. Although it is understood that additional strength may be utilized for other purposes.

By way of example, the minimal thickness of a body having a sealing cavity for a particular type of body material, inner cavity diameter, and pressure rating is set forth in Table I.

TABLE I

| Pressure | Inside diameter in inches | | | | | | | |
|---|---|---|---|---|---|---|---|---|
| Rating in | 2 9/16 | 3⅛ | 4 1/16 | 5⅛ | 6⅜ | 7 1/16 | 9 | 11 |
| psi | Minimum Outside Diameter in inches | | | | | | | |
| 3,000 | 2 11/16 | 3¼ | 4 3/16 | 5 5/16 | 6 9/16 | 7⅜ | 9⅜ | 11⅜ |
| 5,000 | 2¾ | 3 5/16 | 4¼ | 5⅜ | 6¾ | 7 7/16 | 9 7/16 | 11½ |
| 10,000 | 2 13/16 | 3½ | 4½ | 5⅝ | 7 | 7¾ | 9⅞ | 12⅛ |
| 15,000 | 3 | 3⅝ | 4¾ | 6 | 7 5/16 | 8⅛ | 10⅜ | 12⅝ |
| 20,000 | 3⅛ | 3⅞ | 5 | 6¼ | 7⅞ | 8 9/16 | 10⅞ | 13 5/16 |
| Pressure | Inside diameter in inches | | | | | | | |
| Rating in | 2.5625 | 3.1250 | 4.0625 | 5.1250 | 6.3750 | 7.0625 | 9.0000 | 11.0000 |
| psi | Minimum Standard Wall Thickness in inches | | | | | | | |
| 3,000 | 0.1250 | 0.1250 | 0.1250 | 0.1875 | 0.1875 | 0.3125 | 0.3750 | 0.3750 |
| 5,000 | 0.1875 | 0.1875 | 0.1875 | 0.2500 | 0.3750 | 0.3750 | 0 4375 | 0.5000 |
| 10,000 | 0.2500 | 0.3750 | 04375 | 0.5000 | 0.6250 | 0.6875 | 0 8750 | 1.1250 |
| 15,000 | 0.4375 | 0.5000 | 0.6875 | 0.8750 | 0.9375 | 1.0625 | 1 3750 | 1.6250 |
| 20,000 | 0.5625 | 0.7500 | 0.9375 | 1.1250 | 1.5000 | 1.5000 | 1 8750 | 2.3125 |

Well pressure control equipment may be, and in the majority of situations is, an important component of performing a service or operation of a facility, for example, performing a well service or pipeline service operation. Such equipment, methods and techniques can play an important role in the prevention of injury to personnel, harm to the environment and potential loss of facilities. Embodiments of the laser line shearing and sealing devices, systems, methods and apparatus of the present inventions address these issues, and do so with smaller lighter weight devices, that still have the capability to cut through the current and future line structures, rods and tubes, which may be used in such operations. Thus, for example, embodiments of the present laser line structure shearing and sealing devices, systems and apparatus may be used for, in, with, or in conjunction with, well control equipment and procedures, such as: snubbing equipment and operations; wireline equipment and operations; coiled tubing equipment and operations; well intervention equipment and operations; perforating equipment and operations; wireline surface pressure control equipment and operations; coiled tubing surface well control equipment and operations; workover equipment and operations; and equipment and operations to address hydrate formation.

Well pressure control systems, which are designed and intended to handle line structures, are significantly different from drilling BOP systems, which are designed and intended to handle jointed drill pipe, jointed casing, and to be used during drilling operations. The increased size of drilling BOPs, and their configurations, may also make it problematic for these large devices to handle, e.g., trap and cut line structures. The present laser pressure control modules, devices and assemblies further differ from drilling BOP systems, by reducing, and preferably significantly reducing the size, weight, ease of deployment, and ease of use of such systems. It should also be noted that embodiments of the present laser pressure control modules, devices and assemblies may be used with, or in addition to, a intervention BOP systems, wireline BOP systems, and coiled tubing BOP systems. Thus, for example, to the extent that a wireline BOP is incapable of cutting a particular line structure that is going to be used at a well, one or more laser pressure control module(s) can be added to the wireline BOP system to insure that the line structure can be cut and the well closed off. In this embodiment the laser pressure control module may have a laser cutter assembly, or it may have a laser cutter and sealing valve assembly.

Preferably, the bodies, housing or structures of the embodiments of the present laser pressure modules, devices and assemblies are constructed to handle, have the capability to handle, or most preferably have a pressure rating that meets or exceeds the expected surface pressure, e.g., the highest pressure predicted to be exerted upon the surface of a well, which should include the reservoir pressure, as well as applied surface pressure, for which the embodiment is expected to be used.

Operations that may be performed while managing pressure using an embodiment of the present laser modules devices and assemblies, would include for example: operations conducted on a well with the tree installed; cutting paraffin; removing and setting pump-through-type tubing plugs, gas-lift valves, and subsurface safety valves, which can be removed by wireline operations; bailing sand; pressure surveys; swabbing; scale or corrosion treatment; caliper and gauge surveys; corrosion inhibitor treatment; removing or replacing subsurface pumps; through-tubing logging, e.g., diagnostics; wireline fishing; and setting and retrieving subsurface flow-control devices.

Further, and for example, wireline perforating operations, as well as, any wireline operations where communication exists between the completed hydrocarbon-bearing zone(s) and the wellbore may use a lubricator assembly containing a laser wireline valve having a laser cutter associated with the valve to cut any line structure that may be present during the wireline operations.

Laser module rig assist snubbing units can provide a fast and economical means of running tubing under pressure. Thus, providing the ability to work with a live well, which eliminates, greatly reduces, or mitigates the risk of kill fluid damage and the time and expense of unloading fluids from the wellbore.

An example of a deployment and retrieval unit that may be used with, or include an embodiment of the laser modules, devices, systems and assemblies, would include by way of example, a small hydraulic rig assist unit that is gooseneck trailer mounted, or bobtail truck mounted for easy transportation and maneuverability; diesel fuel power units; jack assembly (available with or without work platform); and a pipe handling winch. The unit may also have a wireline BOP, e.g., 5,000 psi BOP. The line structure may be wound around a large (3 to 10 feet in diameter) spool. Such a unit can safely handle most line structures, including for example tubulars up to 3½″ at pressures up to 1500 psi and 2⅞″ and smaller tubing at 2000 psi. Rig up is quick, and usually may take less than about 1 hour.

The laser modules, devices, systems, apparatus and units may be used with may different types of wireline tools, for example the present inventions may be used with: sonic and ultrasonic tools; magnetic resonance tools; borehole seismic tools; cased hole electric line tools; cement bond tools; casing collar locator tools; perforating tools; setting and fishing tools; tractors.

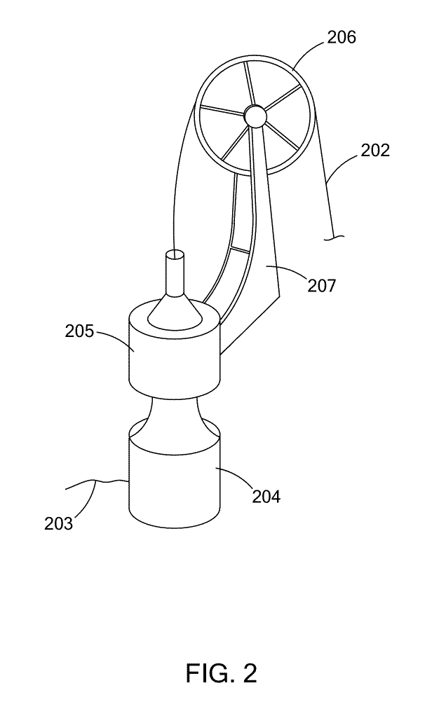

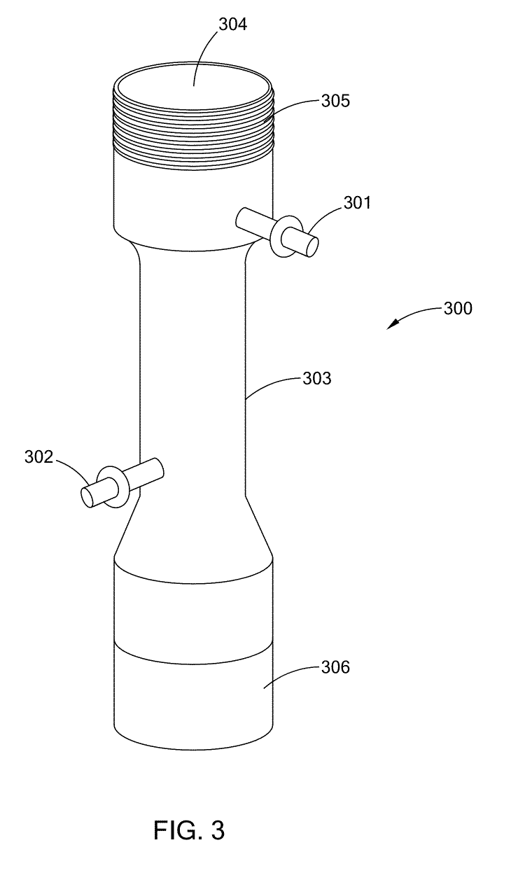

Turning to FIG. 2 there is shown an embodiment of a laser manual slickline stuffing box, which guides the slickline 202 from the bottom hay pulley 206 (held by support frame 207) into the top of the lubricator rig-up 205 and contains well pressure when the slickline is moving or stationary. The laser cutting unit 204 has a laser cable 203 connected to a source of high power laser energy and has beam paths, beam properties, and beam power to cut the slickline present in the cavity, within the laser cutting unit 204. The laser cutting unit 204 may also have a valve for sealing of, shutting off, the well after the laser beam from the laser cutter severs the slickline. In use, the slickline is passed over the sheave wheel and down through a manually energized packing stack in the stuffing box body. Upper and lower bushings are provided to ensure that the slickline is properly guided into the assembly. Internal components may be made from brass and the packing material may be made from a cord filled nitrile. It being recognized that other materials can be used. A laser cutting module and closing valve assembly may also be used with a hydraulic slickline stuffing box, as well as other types of stuffing boxes.

Laser stuffing boxes can handle, e.g., seal against, advance and retrieve, perform service operations, and cut and seal, for example: 0.092″ to 0.125″ slickline, and 0.140″ to 0.160″ slickline, as well as other sizes of slickline and line structures.

Turning to FIG. 3 there is provided a perspective view of an embodiment of a liquid seal stuffing box and laser cutting and sealing assembly 300. This assembly 300 has a liquid stuffing box 303, and a laser cutting assembly and sealing assembly 306. The liquid stuffing box 303 has an opening 304 to an internal cavity, the opening having a threaded connection 305 on its outer side (although other types of connections may be used). The liquid stuffing box 303 has a first fitting 301 and a second fitting 302. This device can be used, for example, with a conventional hydraulic slickline stuffing box, to give the primary seal on a slickline, and maintain pressure integrity when running in and out of a borehole. These devices, preferably may be used on high pressure or hostile wells, although it may be used on any type well, and will provide a lower friction seal than a conventional stuffing box, on any well. The laser cutting and sealing assembly 300, has a laser module and sealing assembly, such as a valve, and may have one, two, or more laser delivery assemblies, each providing a laser beam path and laser beam. In this embodiment the laser cable is internal to the unit and would exit through the fitting, or a separate fitting or connection receptacle. The laser cutting and sealing assembly 306 is capable of laser cutting the slickline present in the cavity and sealing or shutting off the well after the laser beam from the laser cutter severs the slickline.

During normal operation, e.g., before an emergency laser cutting and closing of the laser module sealing assembly, pressure control is achieved by passing the line structure through several closely fitting tube structures and pumping grease into the annulus between the line and these structures, at a pressure slightly above well pressure. The closeness of the fit between the line and these tube structures, combined with the design of the interface between each of them, creates a sequential pressure drop, such that there is no residual well pressure as the wireline exits the top of the assembly of tube structures.

A laser cutting module, device, assembly, or a laser cutting and sealing device, module, or assembly may be use in conjunction with, or as a part of, a grease injection control head. Generally, these devices may be positioned on top of a lubricator or a lubricator rig up, and generally, contain well pressure whilst running braided cable in or out of a well.

A laser cutting module, device assembly, or a laser cutting and sealing assembly may also be used in conjunction with, or as a part of other oil service pressure control related equipment, such as an hydraulic pack off, an in-situ pressure test sub, pump-in tees, tees, and other similar or related types of devices.

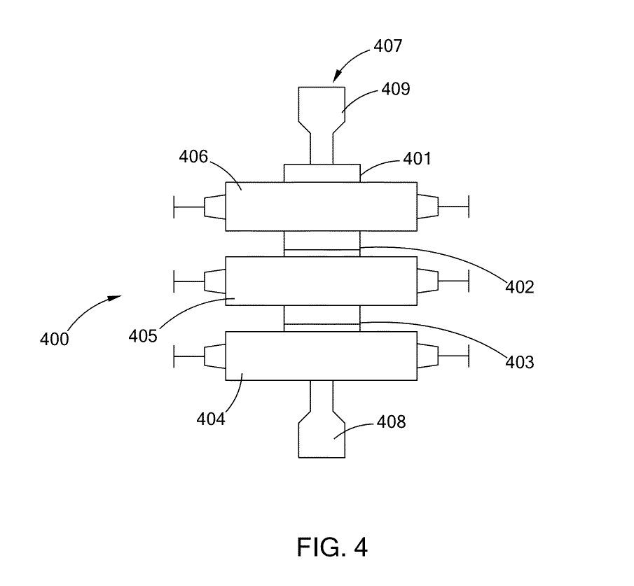

Turning to FIG. 4 there is provided an embodiment of a line structure valve assembly 400. The assembly has three double-sided valves 404, 405, 406 for closing, or shutting off a well. More or fewer valves may be utilized. The assembly has three laser modules, 401, 402, 403 more or fewer may be used. In operation the laser modules, fire a laser beam within the cavity of the assembly, severing any line structure present, so that a valve can close without being obstructed by the line structure. The valve assembly 400 has a connection fitting 409, and a connection fitting 408 and a cavity 407 that extends through the assembly 400.

The use of the laser devices, permits the assembly to have a configuration that is very compact and light weight, because the laser rather than the valves is doing the cutting of the line structure. This compact design provides for several advantages, including for example use in offshore operations, where the assembly is lowered through a restricted hatch space on a deck or platform, for example, onto a Christmas tree. □□ These valve assemblies may, for example: have manual and/or remote hydraulic operated valves; have cavity IDs of from 3.00″ ID to 9.00″ ID; have operating pressures, ratings or capabilities of from about 5,000 psi, about 10,000 psi, about 15,000 psi, to about 20,000 psi, have environmental operating temperature ranges from about −29 to 121 Degrees C., about −20 to 250 Degrees C., about −75 to 650 Degrees C., about −60 to about 345 Degrees C., have quick union or API flanged connections, have the capability to deliver a laser beam in each laser module having at least about 5 kW, about 10 kW, about 20 kW and more; have a cavity or through bore that is about 3.00″, about 4″, about 5⅛″, and about 6⅛.″ The valve assembly parameters and operating capabilities may be larger or smaller than those in the above exemplary ranges.

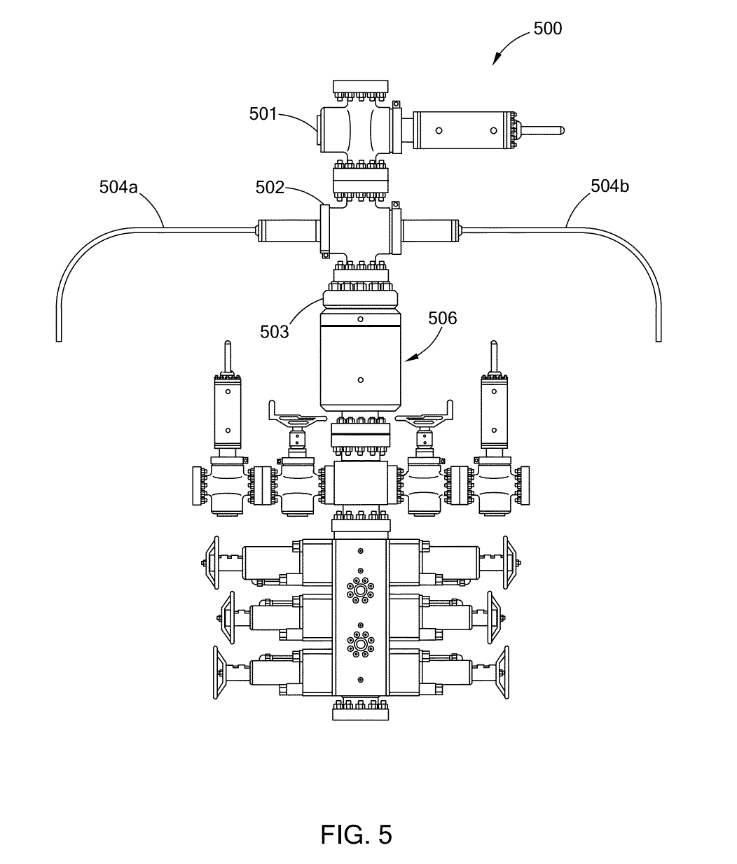

Turning to FIG. 5, there is shown an embodiment of an intervention laser cutting device, as set forth in the drawings and text of this figure. This device may be added above existing pressure control devices and can be fabricated with flange, threaded or hub connectors. Isolation valves can be used to allow isolation once severed objects have been cleared from the valve bore. The device may have one, two, three or more laser heads. When multiple laser heads are used, the laser heads may be configured at various orientations with respect to each other, e.g., 90° or 180°. The intervention laser cutting device 500 has an emergency isolation valve 501, a laser cutting assembly 502, a cross over 503, feed lines 504a, 504b (that have high power laser fibers, connected to a high power laser and fluid lines, for the laser cutter assemblies) and a BOP stack 506.

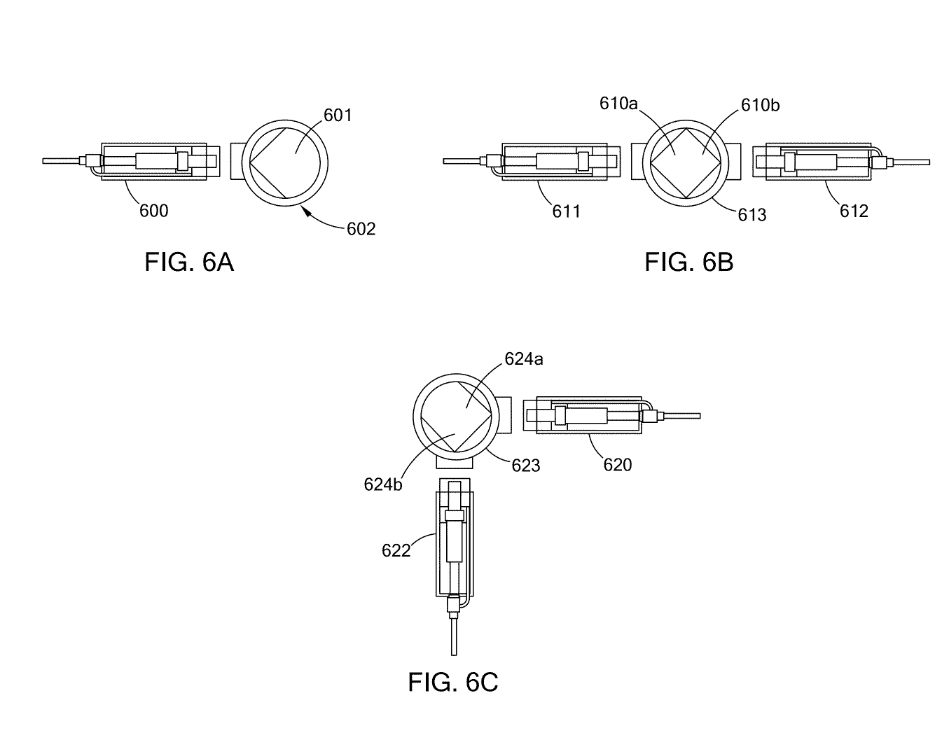

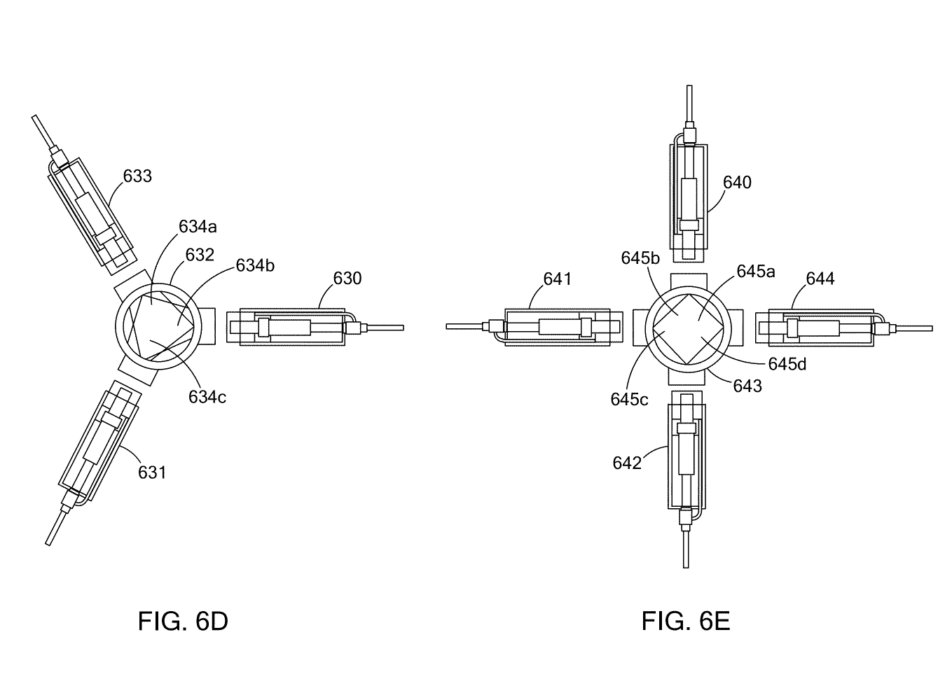

Turning to FIGS. 6A, 6B, 6C, 6D, and 6E there are shown embodiments of laser cutting devices having various configurations of laser heads or laser delivery devices with respect to a body forming a cavity. In these drawings the laser heads are show disassembled from the body, it being understood that in use, the laser heads would be attached, e.g., screwed into, or otherwise mechanically associated with the body.

FIG. 6A depicts an embodiment of a single laser head configuration, having a laser beam delivery device 600, providing a laser beam along beam path 601 in body 602. FIG. 6B depicts an embodiment of a 180° two laser head configuration, having a laser beam delivery device 611, providing a laser beam along laser beam path 610a, and a laser beam delivery device 612, providing a laser beam along laser beam path 610b, both in body 613. FIG. 6C depicts an embodiment of a 90° two laser head configuration, having a laser beam delivery device 622, providing a laser beam along laser beam path 624b, and a laser beam delivery device 620, providing a laser beam along laser beam path 624a, both in body 623. FIG. 6D depicts an embodiment of a three laser head configuration, having a laser beam delivery device 631, providing a laser beam along laser beam path 634c, a laser beam delivery device 630, providing a laser beam along laser beam path 634b, a laser beam delivery device 633, providing a laser beam along laser beam path 634a, all in body 632. FIG. 6E depicts an embodiment of a four laser head configuration, having a laser beam delivery device 642, providing a laser beam along laser beam path 645d, a laser beam delivery device 644, providing a laser beam along laser beam path 645a, a laser beam delivery device 640, providing a laser beam along laser beam path 645b, a laser beam delivery device 641, providing a laser beam along laser beam path 645c, all in body 643.

The laser beam paths, and laser beams traveling along those paths are divergent, i.e., the laser beam broadens as it leaves the laser head and travels into the cavity. The angle of divergence may vary from about 0 degrees, which would essentially be a collimated beam, to about 30 degrees, to about 45 degrees, to about 90 degrees, to about 95 degrees and greater. Preferably, the number, placement and beam divergence angle are selected to provide the maximum, and preferably total coverage of the cavity area.

In addition to a diverging beam, the beam may be focused. The power of the laser beams can be selected based upon the divergence, the diameter of the cavity and other factors, to provide a laser beam fluence that is appropriate to insure that any line structure in the cavity will be cut. Thus, for example, the laser power, beam shape, number of laser heads, and position of lasers about the body may be such that the laser fluence in the cavity is uniform, is substantially uniform, that at least about 90% of the area is uniform, at least about 80% of the are is uniform, and at least about 79% of the area is uniform.

For example, a preferred embodiment of a laser delivery device may consist of a collimated or focused laser beam, a laser beam director and a camera system for tracking the position of the wire within the body. The volume in the cavity is purged with a transmissive fluid, either gas or water. The position of the wire is sensed using a high speed, medium speed, or normal video rate camera and the laser beam will be directed onto the wire using a high speed, medium speed, or low speed beam directing system. The camera has a set of filters to enable it to actively see the wire while the laser beam is incident on the wire. This enables the laser to be continuously trained on the wire to insure it is severed in the shortest time. The laser beam is directed by either a moveable mirror, a moveable prism, a galvometer (high speed motors) or a high speed servo system.

The wire may be centralized using for example a sphincter, which is used to isolate the volume prior to purging with a transmissive fluid such as gas or water. When the volume is purged a laser beam of sufficient width and height will be used to rapidly severe the wire by heating it beyond its yield

The laser beam power, and resultant fluence, are preferably established to minimize, manage, or avoid significant or structural damage to the inside wall of the cavity from the laser beam; and preferably to avoid any damage to that inside wall of the cavity. Further, to address this inside wall damage issue, the surface of the wall, or the wall itself, may be made from materials that reflect the laser beam. The wall of the structure may be lined with a high temperature refractory such as graphite, titanium, alumina, etc.

It further being understood that although a circular body and cavity are shown in the embodiments of the figures, and are preferred, other shapes and configuration may be used, e.g., a square, rectangle, ellipse.

A sufficient laser fluence is required to cut the wire material. This fluence typically requires the use of a focused beam, at least in one axis. In order to scan the cavity with a high fluence line an active zoom system can be used which moves a line focus across the cavity. The line focus can be created using cylindrical, torroidal, or anamorphic optics of a refractory or reflective nature. The focused line can be moved across the cavity by either moving all the optics in unison, i.e. scanning a fixed focal length line across the cavity, or by moving the optics relative to one another, thus creating a change in the effective focal length of the focusing optics system and creating a sweeping effect.

Rather than using a line focus, a focused point, in both axis, may be used. This point can be scanned through the cavity using rastering. A highly focused point can be used, which in this case, the rastering would work in combination with active zoom optics to scan the cavity and create very high fluence areas at every point within the cavity. Alternatively, optical systems may be designed at sufficient power levels to provide an acceptable depth of focus and fluence level to cut the wire anywhere within the cavity. In this way the collimated or semi-collimated beam may be rastered across the cavity. The rastered beam may be circular, elliptical, or any other shape that provides sufficient fluence to cut the wire.

Further, the wire may be cut by providing sufficient energy to heat the wire to its melting point through localized bulk heating. The energy may be delivered directly from the laser delivery device into the laser cavity without application of beam shaping optics or with the use of beam shaping optics to improve its efficiency, i.e. collimation or focusing of the beam energy into the cavity area.

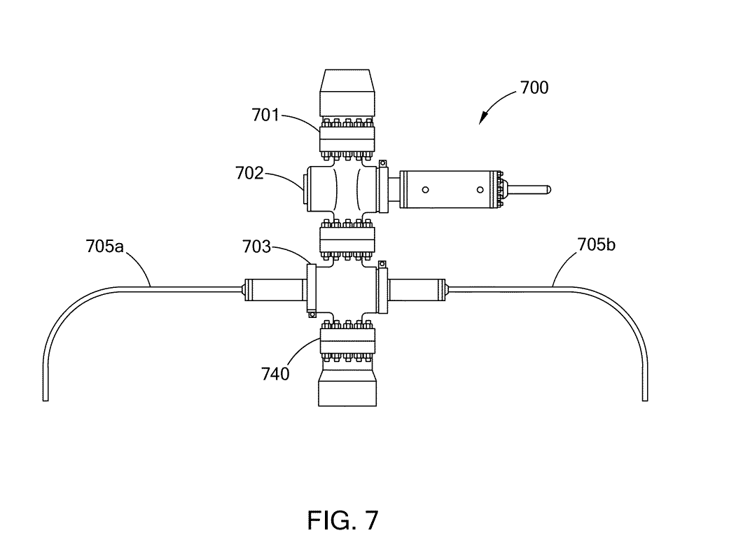

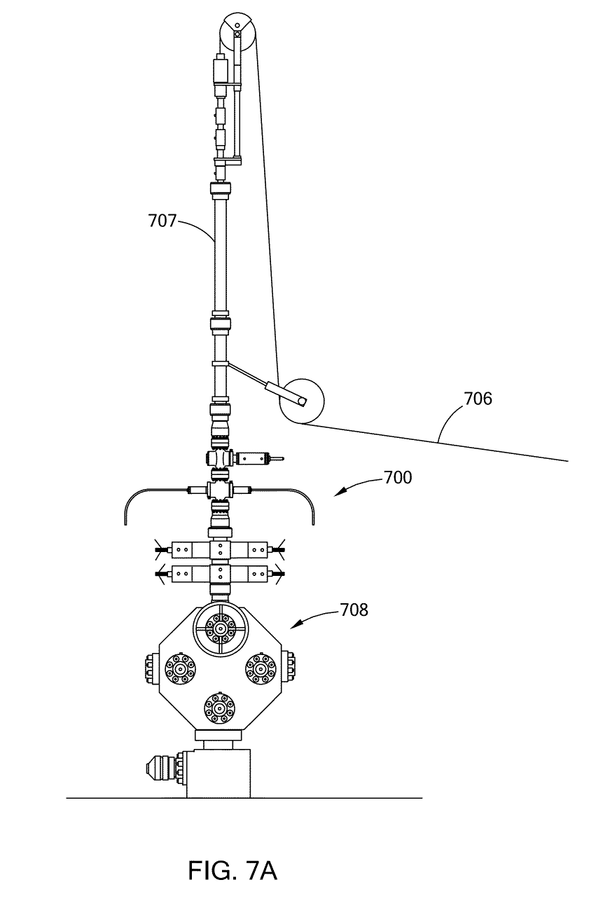

Turning to FIG. 7, and FIG. 7A there is shown an embodiment of a laser intervention system. Turning first to FIG. 7A the embodiment has a wireline/slickline lubricator 707, a wireline or slickline 706, a well head 708 and a laser cutting and sealing assembly 700. Turning now to FIG. 7, there is shown a detailed view of the laser cutting and sealing assembly 700. This assembly has a cross over 701, an isolation valve 702, a laser cutting assembly 703 having feed lines (laser and fluids) 705a, 705b

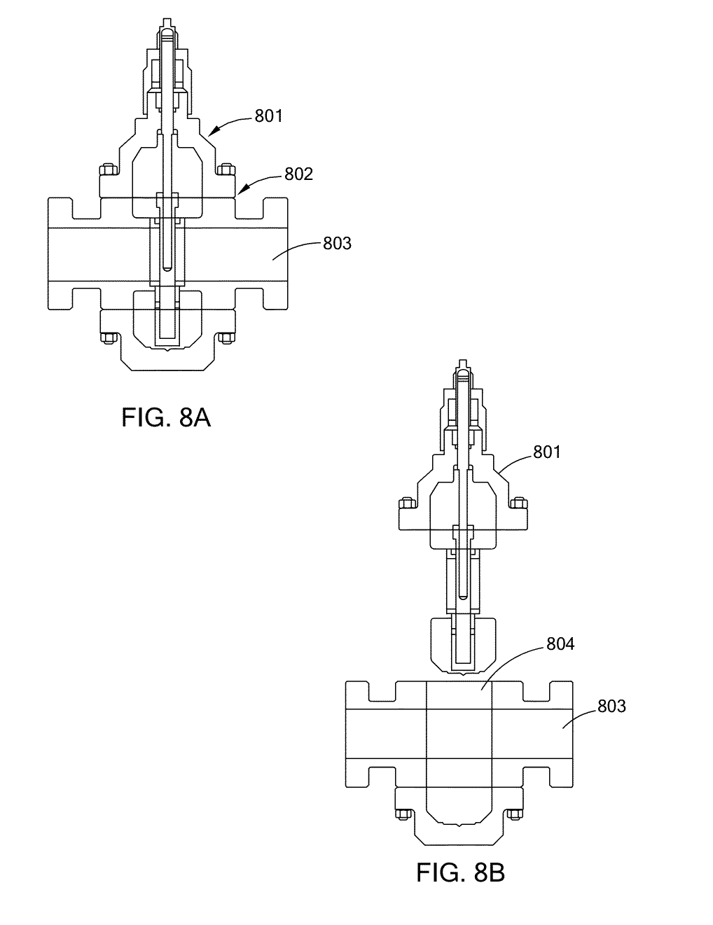

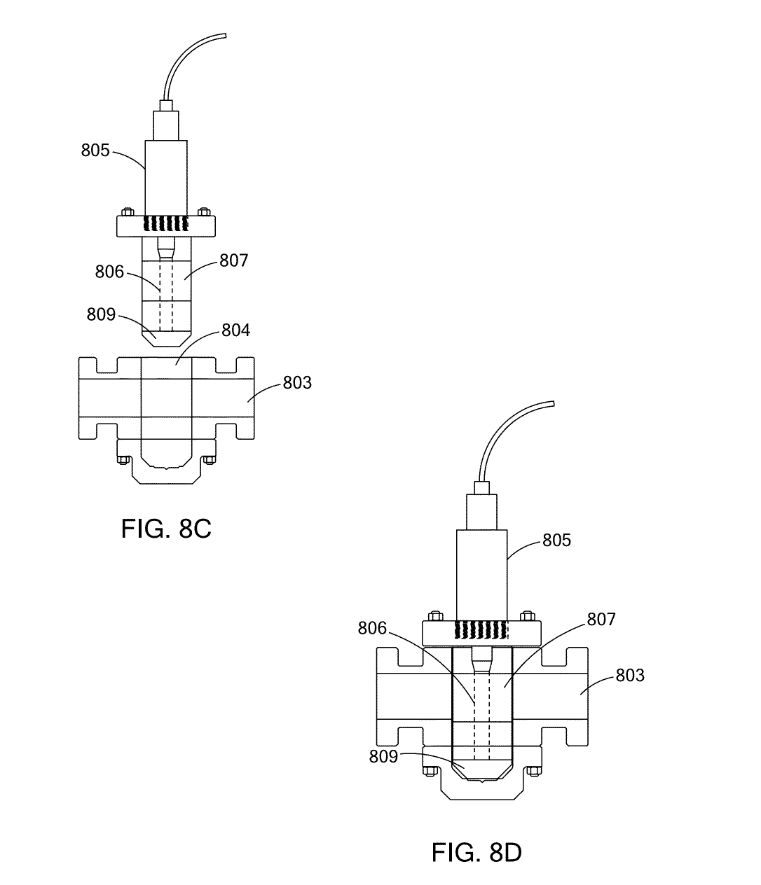

Turning to FIGS. 8A, 8B, 8C and 8D shows a sequence of a process for converting and existing high pressure gate valve having a flow path through the valve body assembly into a high pressure laser cutter assembly. In FIG. 8A there is a high pressure gate valve 802 having a valve bonnet and stem 801 bolted to a body having a cavity 803 extending through the valve body. In FIG. 8B the valve bonnet and stem 801 have been removed from the body leaving a opening 804 that is in fluid communication with the cavity 803. In FIG. 80 the laser cutting head 805 is positioned above the opening 804. The laser cutting head 805 has a cavity 807, which has the laser beam path 806 extending across it to a beam absorptive or reflective material 809. FIG. 8D shows the laser head 805 inserted into the opening and bolted to the body. The laser head cavity 807 and the body cavity 803 are aligned and in fluid communication.

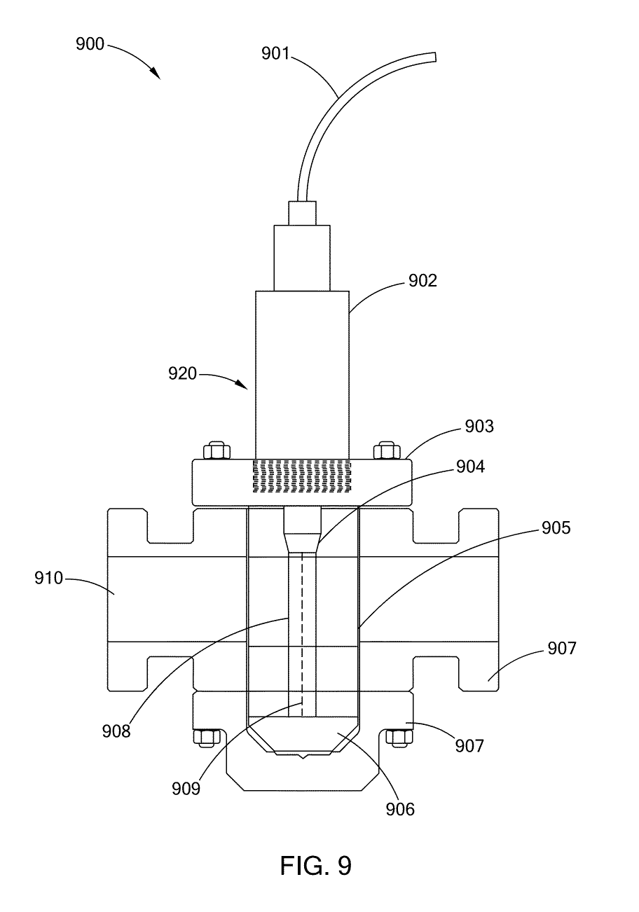

FIG. 9 provides a detailed view of the embodiment of the laser head and valve body assembly 900. In this assembly 900 a standard high pressure gate valve body 907 has had its valve stem and bonnet removed and a laser insert 920 has a flange 903 that is bolted to the body 907. The laser insert 920 has an optics package 902 with a laser cable 901 (which is connected to a high power laser and provides the high power laser beam to the optics package). The laser insert 920 has a laser nozzle 904 (which may be a fluid jet laser and in which case the a source of fluid for the laser jet would be provided to the nozzle). In operation a laser beam 908 is launched upon laser beam path 909 into a beam dump (laser beam absorptive material, or reflective material) There is also a sleeve 905 that has an opening with cavity 910.

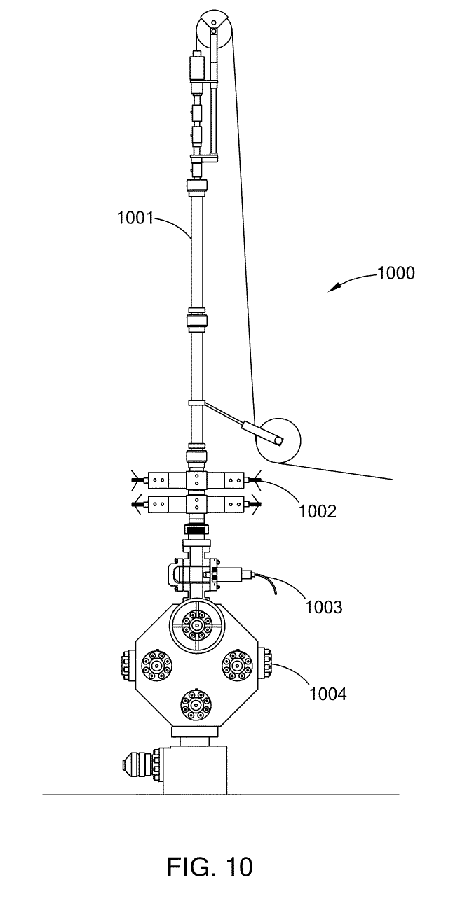

FIG. 10 is an embodiment of a laser pressure control system 1000, as deployed on an active well. This system has a line structure 1002, e.g., a wireline, or slickline, that has a lubricator 1001 (having a grease head or pack-off), a BOP 1002, a laser cutting assembly 1003, e.g., the embodiment of FIG. 9, and a well head 1004.

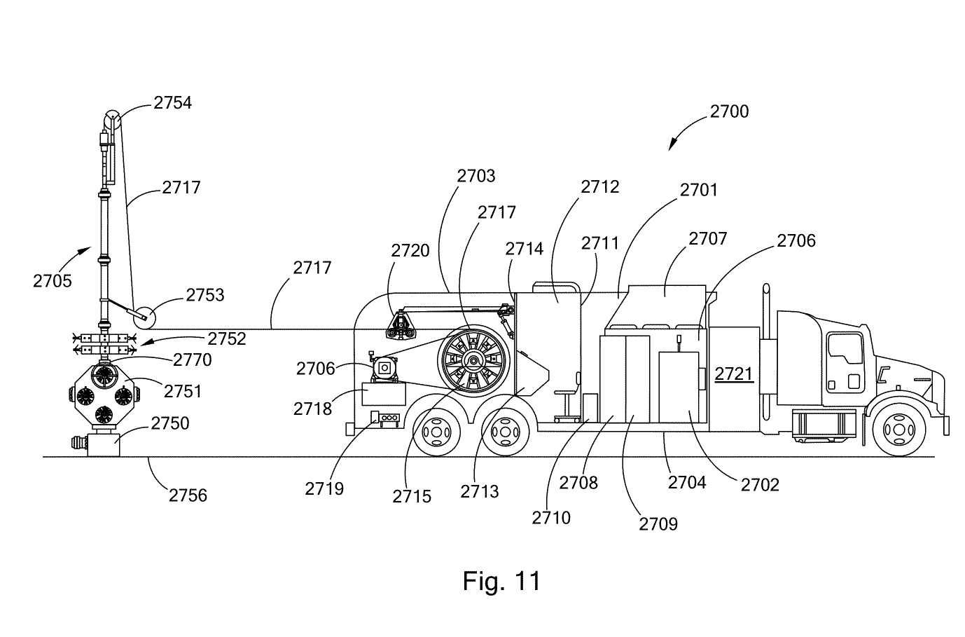

An embodiment of a high power pressure control laser system and its deployment equipment, as deployed in the field are provided in FIG. 11. Thus, there is provided a mobile laser conveyance truck (MLCT) 2700. The MLCT 2700 has a laser cabin 2701 and a handling apparatus cabin 2703, which is adjacent the laser cabin. The laser cabin 2701 and the handling cabin 2703 are located on a truck chassis 2704. The MLCT 2700 has associated with it a lubricator 2705, for pressure management upon entry into a well.

The laser cabin 2701 houses a high power fiber laser 2702, (20 kW; wavelength of 1070-1080 nm); a chiller assembly 2706, which has an air management system 2707 to vent air to the outside of the laser cabin and to bring fresh air in (not shown in the drawing) to the chiller 2706. The laser cabin also has two holding tanks 2708, 2709. These tanks are used to hold fluids needed for the operation of the laser and the chiller during down time and transit. The tanks have heating units to control the temperature of the tank and in particular to prevent the contents from freezing, if power or the heating and cooling system for the laser cabin was not operating. A control system 2710 for the laser and related components is provided in the laser cabin 2701. A partition 2711 separates the interior of the laser cabin from the operator booth 2712.

The operator booth contains a control panel and control system 2713 for operating the laser, the handling apparatus, and other components of the system. The operator booth 2712 is separated from the handling apparatus cabin 2703 by partition 2714.

The handling apparatus cabin 2703 contains a spool 2715 (about 6 ft OD, barrel or axle OD of about 3 feet, and a width of about 6 feet) holding about 10,000 feet of line structure 2717. This line structure may be a conventional line structure, such as a wireline, braided line, or slickline, or it could be a high power laser conveyance structure for operations with a high power downhole laser tool. The spool 2715 has a motor drive assembly 2706 that rotates the spool. The spool has a holding tank 2718 for fluids that may be used with a laser tool or otherwise pumped through the line structure and has a valve assembly for receiving high pressure gas or liquids for flowing through the line structure, if needed.

The laser 2702 may be optically associated with the line structure 2717 on the spool 2715 by way of an optical fiber and optical slip ring (not shown in the figures). If the line structure is a high power laser conveyance structure for use with a laser tool. The laser 2702 is optically connected to the laser cutting device by a high power laser cable (not shown in the drawings). The fluid tank 2718 and the valve assembly 2719 are in fluid communication with the line structure 2717 on the spool 2715 by way of a rotary slip ring (not shown).

The laser cabin 2701 and handling apparatus cabin 2703 have access doors or panels (not shown in the figures) for access to the components and equipment, to for example permit repair, replacement and servicing. At the back of the handling apparatus cabin 2703 there are door(s) (not shown in the figure) that open during deployment for the conveyance structure to be taken off the spool. The MLCT 2700 has a generator 2721 to provide electrical power to the system.

The MLCT 2700 is positioned near a wellhead 2750 having a Christmas tree 2751, a laser cutting device, such as the device shown in FIG. 9, a wireline BOP 2752 and a lubricator 2705. The line structure 2717 travels through a winder (e.g., line guide, level wind) to a first sheave 2753, to a second sheave 2754, which has a weight sensor associated with it. The line structure 2717 enters into the top of the lubricator and is advanced through the wireline BOP 2752, laser cutting device, tree 2751 and wellhead 2750 into the borehole (not shown) below the surface of the earth 2756. The sheaves 2753, 2754 have a diameter of about 3 feet.

In the event of an emergency situation, or other situation where there is a need to close the well of quickly, the laser cutter can fire a laser beam from the laser and cut the line structure 2717, which can then be pulled up, out of the area of the wireline BOP 2752, which can be closed without any interference from the line structure, and seal the well.

By way of example, the laser delivery assemblies and optical cables may be of the type disclosed and taught in the following US patent application publications and US patent applications: Publication Number 2010/0044106; Publication Number 2010/0044105; Publication Number 2010/0044103; Publication Number 2010/0215326; Publication Number 2012/0020631; Publication Number 2012/0074110; Publication No. 2012/0068086; Ser. No. 13/403,509; Ser. No. 13/486,795; Ser. No. 13/565,345; Ser. No. 61/605,429; and Ser. No. 61/605,434 the entire disclosures of each of which are incorporated herein by reference.

Laser cutters, and laser delivery assemblies of the type disclosed and taught in the following US patent applications: Ser. No. 13/034,183; Ser. No. 13/034,017; Ser. No. 13/034,037, and Ser. No. 61/798,597, the entire disclosures of each of which are incorporated herein by reference, may be used as a laser cutter.

Generally, line structure interventions, such as wireline interventions, are light interventions, and do not require the application of a drilling BOP or heavy equipment. Thus the intervention equipment can be easy to assemble and move, they are lighter and as such, among other reasons, they can improve the number of interventions that can be performed, providing for example, improved production of a well or field. These interventions can be performed either onshore or offshore, above the surface of a body of water or subsea, and can be done as a riser less intervention.

In most cases, line structure interventions can be done underbalanced, e.g., reservoir pressure is greater than well pressure, and accordingly the well is producing hydrocarbons. Examples of line structures that may be used with laser pressure control equipment in underbalance operations includes for example: slick line wireline ( 41/500″, 23/250″, 21/20″, 27/250″, ⅛″); braided line wireline ( 3/16″, 7/32″, ¼″ and 5/16″); heavy duty die-formed slick fishing line ( 7/32″, 5/16″); mono-conductor wireline (a single electrical conductor; 3/16″, 7/32″, 5/16″, ⅜″, 7/16″); coaxial mono-conductor for perforation and production logging ( 5/16″); multi-conductor logging wireline ( 15/32″).

Slickline, which is also referred to as piano wire is a small diameter, continuous, solid wire, which is generally only capable of pulling or pushing by, for example a jarring action. It can be used with laser pressure control systems for operations such as fishing, gauge cutting, setting or removing plugs, deploying or removing wireline retrievable valves and memory logging. Slickline may have a breaking strength of about between 7800 N and 12 380 N, but may be stronger.

Laser pressure control systems, equipment and methods may be used with line structures, such as slickline, in well interventions or well services operations such as: running and pulling plugs, chokes, check valves, etc.; opening and closing circulation devices, circulation valves; checking debris inside a tubing; checking for waxes, scale, corrosion; tubing perforations; cleaning debris inside the tubing and completion components; running and pulling gas lift or chemical injection equipment; running and pulling DHSV and its inserts; bottom hole sampling; depth measurement; and, fishing for lost objects.

Generally, braided line can be more complex than slickline. Grease injection system, as part of an overall laser pressure control system, is generally preferred when using braided line to ensure that the intervention BOP, if present, can seal around the braided contours of the line. The laser shear systems provide an advantage of conventional non-laser system in that for example the same laser system that is qualified to cut slickline can be qualified to cut braided line, and other types of line structures as well. Braided line can generally be used for heavier duty pulling work. It can have two layers of spirally coiled armor wire. A braided line without an electric conductor in the middle may also be called a sand line and can function as a heavy duty slickline. Braided line can be core-less variety used for heaving fishing and electric-line used for logging and perforating. Laser pressure control systems, equipment and methods may be used with line structures, such as braided line, in well interventions or well services operations such as: fishing for lost objects; heavy duty fishing; running both temperature and pressure gauges; running memory measurement device; and in general, tasks that can be performed by a slickline.

In general electrical line or mono-conductor cable is a braided line with one or more electric conductors contained in the line structure and generally in the middle. This line structure can be used for example with intervention tools that need an electrical power or signal. These line structures can have one, two three, or more electrical lines and may have for example 7 or more electrical conductors, e.g., logging cables. A laser pressure control system can cut electrical line.

Preferably, a single laser pressure control system will be qualified to and capable of cutting all types of available line structures, e.g., the laser cutter can readily cut slickline, braided line and electrical line.

High power laser systems, which may include, conveyance structures for use in delivering high power laser energy over great distances and to work areas where the high power laser energy may be utilized, or they may have a battery operated, or locally powered laser, by other means. Preferably, the system may include one or more high power lasers, which are capable of providing: one high power laser beam, a single combined high power laser beam, multiple high power laser beams, which may or may not be combined at various point or locations in the system, or combinations and variations of these.

The laser modules, laser pressure management devices and applications of the present invention may be used with, in, or in conjunction with, existing well intervention, service, workover, and completion equipment, such as FMC's RiserLess Light Well Intervention, which uses FMC's RLWI stack; lubricators, and similar types of riserless subsea systems; devices of the type disclosed and taught in U.S. Pat. No. 6,609,571; and, devices of the type disclosed and taught in U.S. Pat. No. 7,578,349, the entire disclosures of each of which are incorporated herein by reference.

The systems and devices of U.S. Pat. No. 7,578,349 ('349 patent) are directed to a lightweight Intervention package, but essential fail to meet that patents goals. The systems and devices of the '349 patent could greatly be improved by the integration of, or use of, a laser pressure containment assembly. An emphasis on the system of the '349 patent is that it should be a light weight package, specifically designed for intervention applications, with the ability to deploy by means other than a semi submersible or comparable. A goal of the '349 patent is to have the ability to cut 2.875″ CT, wireline, production tubing or 0.204″ wall thickness, or tubulars of at least 2.75″ or more, in a inside diameter component of ˜7.0″, with the primary cut/seal being with a failsafe gate valve. It is however, very unlikely and will be exceeding difficult, if even possible, to have a gate valve of this capability and versatility. If such a gate valve could be obtained it would be a very large, substantial and heavy component. The size being needed to sever the intended structures. Thus, the likely size of any gate valve that would meet the stated desired performance criteria of the '349 patent would be so large and heavy as to defeat the '349 patent's goal of having a lightweight intervention package. Removing the large gate valve and using a laser cutting device in the system would greatly reduce the weight and size of the system, while at the same time likely increase the reliability of cutting the intended structures. This could then be used in conjunction with a standard fail-safe gate valve to seal the well. The valve is the weight and size savings, as well as the more reliable severing of items over the gate valve.

The FMC system is effectively a wireline only system with a severing component in the Upper Lubricator Package and in the Well Control Package. The upper cutting component is a ball valve, the lower a BOP ram. The ball valve would be considered last option isolation should a well control issue arise, and this ball valve is a less than reliable to perform the dual duty of severing and sealing. Use of a laser cutter assembly in addition to, or in the place of the ball valve, would provided a smaller (in the case of substitution) and more reliable way to cut the wire line at the upper position, allowing the isolation valve to be closed without possible issue with wire compromising the seal mechanism of the valve.

Generally, the it should be noted in both the FMC system and the '349 patent system and other conventional intervention systems, the systems are designed for a single wire or line across the valve, e.g., the cutting and sealing assembly. However, although on rare occasions, due to mishaps, multiple strings of the wire or line may be within the bore area and need to be cut by the sealing member. The presences of multiple lines or strings can be very problematic for conventional systems. The laser pressure control systems, and laser cutters, can readily and easily cut multiple strings, e.g, one, two, three or more, that may be present in the cavity, or otherwise present in a manner that would interfere with the sealing of the well.

The systems and devices of U.S. Pat. No. 6,609,571 ('571 patent) are essentially a sub-sea wireline lubricator. This lubricator can be used to drop a tool, housed within the lubricator, down to a well. The lubricator (containing the tool) is then connected to the well using an ROV, so that the tool can then be deployed into the well for an intervention procedure. Although vague in the patent, they mention attaching to a BOP system, not a wellhead. If a BOP system were present, it would most likely not be one fitted for wireline, and thus addressing a pressure control situation with the tool deployed by wireline could prove to be problematic, difficult or impossible. This in turn would require the wellhead, which is not equipped to handle wireline, to attempt to function in a well control situation, by closing valves and hoping that the valve severs the wire and seals. This would be a highly problematic practice, and especially with newer and tougher wirelines, may have a considerable risk of failure. The only remaining well control component in the '571 patent's system, is the grease-head pack-off assembly. However, this assembly does not provide the necessary redundancy or reliability. Essentially all of the issues, problems and risk associated with the system of the '571 patent, could be mitigated and solved by the use of a small laser cutting device positioned at the lower portion of the lubricator. The addition of the laser cutter would allow the cutting of the wire and having it drop below the wellhead or BOP bores to allow closing should the pack-off fail, or other issues dictate rapid removal, or a rapid response.

A single high power laser may be utilized in the system, or the system may have two or three high power lasers, or more. High power solid-state lasers, specifically semiconductor lasers and fiber lasers are preferred, because of their short start up time and essentially instant-on capabilities. The high power lasers for example may be fiber lasers or semiconductor lasers having 10 kW, 20 kW, 50 kW or more power and, which emit laser beams with wavelengths in the range from about 455 nm (nanometers) to about 2100 nm, preferably in the range about 800 nm to about 1600 nm, about 1060 nm to 1080 nm, 1530 nm to 1600 nm, 1800 nm to 2100 nm, and more preferably about 1064 nm, about 1070-1080 nm, about 1360 nm, about 1455 nm, 1490 nm, or about 1550 nm, or about 1900 nm (wavelengths in the range of 1900 nm may be provided by Thulium lasers).

An example of this general type of fiber laser is the IPG YLS-20000. The detailed properties of which are disclosed in US patent application Publication Number 2010/0044106.

Examples of lasers, conveyance structures, high power laser fibers, high power laser systems, optics, connectors, cutters, and other laser related devices, systems and methods that may be used with, or in conjunction with, the present inventions are disclosed and taught in the following US patent application publications and US patent applications: Publication Number 2010/0044106; Publication Number 2010/0044105; Publication Number 2010/0044103; Publication Number 2010/0215326; Publication Number 2012/0020631; Publication Number 2012/0074110; Publication No. 2012/0068086; Ser. No. 13/403,509; Ser. No. 13/486,795; Ser. No. 13/565,345; Ser. No. 61/605,429; Ser. No. 61/605,434; Ser. No. 61/734,809; and Ser. No. 61/786,763, the entire disclosures of each of which are incorporated herein by reference.

An embodiment of a high power pressure control laser system and its deployment equipment, as deployed in the field are provided in FIG. 11. Thus, there is provided a mobile laser conveyance truck (MLCT) 2700. The MLCT 2700 has a laser cabin 2701 and a handling apparatus cabin 2703, which is adjacent the laser cabin. The laser cabin 2701 and the handling cabin 2703 are located on a truck chassis 2704. The MLCT 2700 has associated with it a lubricator 2705, for pressure management upon entry into a well.

The laser cabin 2701 houses a high power fiber laser 2702, (20 kW; wavelength of 1070-1080 nm); a chiller assembly 2706, which has an air management system 2707 to vent air to the outside of the laser cabin and to bring fresh air in (not shown in the drawing) to the chiller 2706. The laser cabin also has two holding tanks 2708, 2709. These tanks are used to hold fluids needed for the operation of the laser and the chiller during down time and transit. The tanks have heating units to control the temperature of the tank and in particular to prevent the contents from freezing, if power or the heating and cooling system for the laser cabin was not operating. A control system 2710 for the laser and related components is provided in the laser cabin 2701. A partition 2711 separates the interior of the laser cabin from the operator booth 2712.

The operator booth contains a control panel and control system 2713 for operating the laser, the handling apparatus, and other components of the system. The operator booth 2712 is separated from the handling apparatus cabin 2703 by partition 2714.

The handling apparatus cabin 2703 contains a spool 2715 (about 6 ft OD, barrel or axle OD of about 3 feet, and a width of about 6 feet) holding about 10,000 feet of line structure 2717. This line structure may be a conventional line structure, such as a wireline, braided line, or slickline, or it could be a high power laser conveyance structure for operations with a high power downhole laser tool. The spool 2715 has a motor drive assembly 2706 that rotates the spool. The spool has a holding tank 2718 for fluids that may be used with a laser tool or otherwise pumped through the line structure and has a valve assembly for receiving high pressure gas or liquids for flowing through the line structure, if needed.

The laser 2702 may be optically associated with the line structure 2717 on the spool 2715 by way of an optical fiber and optical slip ring (not shown in the figures). If the line structure is a high power laser conveyance structure for use with a laser tool. The laser 2702 is optically connected to the laser cutting device by a high power laser cable (not shown in the drawings). The fluid tank 2718 and the valve assembly 2719 are in fluid communication with the line structure 2717 on the spool 2715 by way of a rotary slip ring (not shown).

The laser cabin 2701 and handling apparatus cabin 2703 have access doors or panels (not shown in the figures) for access to the components and equipment, to for example permit repair, replacement and servicing. At the back of the handling apparatus cabin 2703 there are door(s) (not shown in the figure) that open during deployment for the conveyance structure to be taken off the spool. The MLCT 2700 has a generator 2721 to provide electrical power to the system.

The MLCT 2700 is positioned near a wellhead 2750 having a Christmas tree 2751, a laser cutting device, such as the device shown in FIG. 9, a wireline BOP 2752 and a lubricator 2705. The line structure 2717 travels through a winder (e.g., line guide, levelwind) to a first sheave 2753, to a second sheave 2754, which has a weight sensor associated with it. The line structure 2717 enters into the top of the lubricator and is advanced through the wireline BOP 2752, laser cutting device, tree 2751 and wellhead 2750 into the borehole (not shown) below the surface of the earth 2756. The sheaves 2753, 2754 have a diameter of about 3 feet.

In the event of an emergency situation, or other situation where there is a need to close the well of quickly, the laser cutter can fire a laser beam from the laser and cut the line structure 2717, which can then be pulled up, out of the area of the wireline BOP 2752, which can be closed without any interference from the line structure, and seal the well.

These various embodiments of conveyance structures may be used with these various high power laser systems. The various embodiments of systems and methods set forth in this specification may be used with other high power laser systems that may be developed in the future, or with existing non-high power laser systems, which may be modified in-part based on the teachings of this specification, to create a laser system. These various embodiments of high power laser systems may also be used with other conveyance structures that may be developed in the future, or with existing structures, which may be modified in-part based on the teachings of this specification to provide for the utilization of directed energy as provided for in this specification. Further the various apparatus, configurations, and other equipment set forth in this specification may be used with these conveyance structures, high power laser systems, laser delivery assemblies, connectors, optics and combinations and variations of these, as well as, future structures and systems, and modifications to existing structures and systems based in-part upon the teachings of this specification. Thus, for example, the structures, equipment, apparatus, and systems provided in the various Figures and Examples of this specification may be used with each other and the scope of protection afforded the present inventions should not be limited to a particular embodiment, configuration or arrangement that is set forth in a particular embodiment in a particular Figure.

Many other uses for the present inventions may be developed or realized and thus the scope of the present inventions is not limited to the foregoing examples of uses and applications. The present inventions may be embodied in other forms than those specifically disclosed herein without departing from their spirit or essential characteristics. The described embodiments are to be considered in all respects only as illustrative and not restrictive.

What is claimed:

1. A laser pressure control system comprising:
a. a body having a wall defining a first cavity;
b. the body have a connection for connecting the body to a pressurized system and thereby placing the cavity in fluid communication with the pressurized system;
c. the cavity having an inner diameter from about 2.5 inches to about 11 inches, and the wall having a thickness of about 0.12 inches to about 3 inches, and the body capable of holding a well pressure of from about 2,000 psi to about 20,000 psi; and,
d. a laser device associated with the body and providing a laser beam path in the cavity for propagation of a high power laser beam along the laser beam path;
e. wherein, the laser beam path is configured to provide a laser beam fluence in substantially an entire cross sectional area of the cavity; whereby a structure present in the cavity will be cut by the laser beam.

2. The system of claim 1, wherein the body comprises a ball valve.

3. The system of claim 1, wherein the body comprises a gate valve.

4. The system of claim 1, wherein the body comprises a sealing means.

5. The system of claim 1, wherein the laser beam has a power of at least about 5 kW.

6. The system of claim 1, comprising: a fiber laser having at least about 10 kW of power; a means for sealing the well; whereby, the system is capable of closing off the well and containing a well fluid, when the well has a well pressure of less than about 30,000 psi.

7. The system of claim 1, comprising: a fiber laser having at least about 20 kW of power; a means for sealing the well; whereby, the system is capable of closing off the well and containing a well fluid, when the well has a well pressure of more than about 10,000 psi.

8. The system of claim 1, wherein the cavity diameter is about 3.1250 inches, the wall thickness is about 0.1250 inches and the well pressure capability is about 3,000 psi.

9. The system of claim 1, wherein the cavity diameter is about 3.1250 inches, the wall thickness is about 0.5000 inches and the well pressure capability is about 15,000 psi.

10. The system of claim 1, wherein the cavity diameter is about 6.3750 inches, the wall thickness is about 1.500 inches and the well pressure capability is about 20,000 psi.

11. The system of claim 1, wherein the structure is a line structure.

12. The system of claim 11, wherein the structure is a wireline

13. The system of claim 1, wherein the structure is a rod

14. The system of claim 1, wherein the structure is tubing.

15. The system of claim 2, wherein the structure is a line structure.

16. The system of claim 3, wherein the structure is a line structure.

17. The system of claim 4, wherein the structure is a line structure.

18. The system of claim 6, wherein the structure is a line structure.

19. The system of claim 9, wherein the structure is a line structure.

20. The system of claim 10, wherein the structure is a line structure.

21. A well intervention laser pressure control system comprising:
a. a valve body defining a first and a second cavity;
b. the first cavity intersecting the second cavity;
c. the body having a first connector and second connector, each connector defining a cavity in fluid communication with the first cavity, whereby the first cavity, the first connector cavity and the second connector cavity define a flow channel,
d. the flow channel having an inner diameter from about 1.5 inches to about 11 inches, and the body capable of holding a well pressure of from about 2,000 psi to about 20,000 psi; and,
e. a laser device associated with the body, and positioned in the second cavity for propagation of a high power laser beam along the laser beam path;
f. the laser device providing a laser beam path, the laser beam path traveling through the first and the second cavities; and,
g. wherein, the laser beam path is configured to provide a laser beam fluence; whereby a structure present in the cavity will be cut by the laser beam.

22. The system of claim 21, wherein the body comprises a ball valve.

23. The system of claim 21, wherein the body comprises a gate valve.

24. The system of claim 21, wherein the body comprises a sealing means.

25. The system of claim 21, wherein the laser beam has a power of at least about 5 kW.

26. The system of claim 21, comprising: a fiber laser having at least about 10 kW of power; a means for sealing the well; whereby, the system is capable of closing off the well and containing a well fluid, when the well has a well pressure of less than about 30,000 psi.

27. The system of claim 21, comprising: a fiber laser having at least about 20 kW of power; a means for sealing the well; whereby, the system is capable of closing off the well and containing a well fluid, when the well has a well pressure of more than about 10,000 psi.

28. The system of claim 21, wherein the cavity diameter is about 3.1250 inches, the wall thickness is about 0.1250 inches and the well pressure capability is about 3,000 psi.

29. The system of claim 21, wherein the cavity diameter is about 3.1250 inches, the wall thickness is about 0.5000 inches and the well pressure capability is about 15,000 psi.

30. The system of claim 21, wherein the cavity diameter is about 6.3750 inches, the wall thickness is about 1.500 inches and the well pressure capability is about 20,000 psi.

31. The system of claim 21, wherein the structure is a line structure.

32. The system of claim 31, wherein the structure is a wireline.

33. The system of claim 31, wherein the structure is a slickline.

34. The system of claim 21, wherein the structure is a rod.

35. The system of claim 21, wherein the structure is tubing.

36. The system of claim 23, wherein the structure is a line structure.

37. The system of claim 24, wherein the structure is a line structure.

38. The system of claim 25, wherein the structure is a line structure.

39. The system of claim 27, wherein the structure is a line structure.

40. The system of claim 21, comprising a laser beam dump positioned at the end of the laser beam bath.

41. The system claim 40, wherein the laser beam dump is positioned in the second cavity in a manner that does not obstruct the flow channel.

42. A laser module for use in a well intervention laser pressure control system, the laser module comprising:
a. a body having a wall defining a chamber;
b. the chamber having an inner diameter from about 1 inch to about 11 inches, and the wall having a thickness of about 0.12 inches to about 3 inches, and the body capable of holding a pressure in the chamber of at least about 2,000 psi;
c. a laser delivery device attached to the body and optically associated with the chamber; and,
d. a laser delivery device configured to provide a laser beam having a predetermined fluence, pattern and path, extending into the chamber;
e. wherein the predetermined laser beam fluence, pattern and path is capable of cutting a structure present in the chamber while not damaging the chamber wall.

43. A laser module for use in a well intervention laser pressure control system, the laser module comprising:
a. a body having a wall defining a chamber;
b. the chamber having an inner diameter from about 1 inch to about 11 inches, and the wall having a thickness of about 0.12 inches to about 3 inches, and the body capable of holding a pressure in the chamber of at least about 2,000 psi;
c. a laser delivery device attached to the body and optically associated with the chamber; and,
d. a plurality of laser delivery devices configured to provide a plurality of laser beams, each beam having a predetermined fluence, pattern and path, extending into the chamber;
e. wherein the combined predetermined laser beams fluence, pattern and path is capable of cutting a structure present in any position within the chamber, while not damaging the chamber wall.

44. A method of retrofitting a conventional valve body in a well control system, the method comprising:
a. identifying a valve assembly, the valve assembly comprising: a body defining a cavity capable of being in fluid communication with a well, and an opening, the opening containing a valve bonnet and stem assembly; and,
b. removing the valve bonnet and stem assembly and inserting into the opening a laser cutting head.

45. A wireline laser pressure control assembly comprising:
a. an emergency isolation valve
b. a laser emergency cutting assembly;
c. a high power optical fiber in optical association with the laser emergency cutting assembly; and,
d. a crossover.

46. The assembly of claim 45, comprising an intervention BOP.

47. The assembly of claim 45, comprising a wireline BOP.

48. The assembly of claim 45, comprising a lubricator.

49. The system of claim 1, wherein the pressurized system is an oil well.

50. The system of claim 1, wherein the pressurized system is a natural gas well.

51. The system of claim 1, wherein the pressurized system is contained within a chemical plant.

52. The system of claim 1, wherein the pressurized system is a pipeline.

53. A pipeline laser pressure control system comprising:
a. a body having a wall defining a first cavity;
b. the body have a connection for connecting the body to a pipeline and thereby placing the cavity in fluid communication with the pipeline;
c. the cavity having an inner diameter from about 2.5 inches to about 11 inches, and the wall having a minimum thickness of about 0.12 inches to about 2.3 inches, and the body capable of holding a pipeline pressure of from about 3,000 psi to about 20,000 psi; and,
d. a laser device associated with the body and providing a laser beam path in the cavity for propagation of a high power laser beam along the laser beam path;
e. wherein, the laser beam path is configured to provide a laser beam fluence in substantially an entire cross sectional area of the cavity; whereby a line structure present in the cavity will be cut by the laser beam.
